(19) United States
(12) Patent Application Publication
(10) Pub. No.: US 2013/0337176 A1
(43) Pub. Date: Dec. 19, 2013

(54) NANO-SCALE VOID REDUCTION

(71) Applicants: Justin Jia-Jen Hwu, Fremont, CA (US); Gennady Gauzner, San Jose, CA (US); Thomas Larson Greenberg, Berkeley, CA (US)

(72) Inventors: Justin Jia-Jen Hwu, Fremont, CA (US); Gennady Gauzner, San Jose, CA (US); Thomas Larson Greenberg, Berkeley, CA (US)

(73) Assignee: SEAGATE TECHNOLOGY LLC, Scotts Valley, CA (US)

(21) Appl. No.: 13/527,584

(22) Filed: Jun. 19, 2012

(51) Int. Cl. B05D 5/00; B05C 9/12; B05D 3/12

(52) U.S. Cl. 427/277; 118/102; 118/50

(57) ABSTRACT

Resist imprinting void reduction method may include sealing a chamber. The chamber may be filled with an ambient inert gas, wherein the inert gas a solubility in a resist layer on a substrate greater than Helium. The method may also include establishing a pressure within the chamber sufficient to cause absorption of the ambient inert gas by the resist layer, and sufficient to suppress evaporation of the resist layer.

### FIELD

Embodiments according to the present invention generally relate to patterned media processing.

### BACKGROUND OF THE INVENTION

Resist ink dispensing, imprinting, and UV exposure are lithographic steps in patterned media processing. Resist droplet dispensing uses a small amount of resist material, thus resulting in uniform residual layer control on features of different densities. Furthermore, resist droplet dispensing for resist film formation can provide a relatively high throughput with a simpler tooling design.

The resist film forming process after resist drop dispensing includes initial droplet wetting followed by subsequent merging of the droplet array during template/disc engagement. The merged droplet array conforms to a topographically patterned surface of the template. The template is separated from the disc, leaving the topographically patterned surface on the disc.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a simplified cross-sectional view of an imprint lithography operation within a chamber, according to an embodiment of the present invention.

FIG. 2 is a simplified cross-sectional view of an imprint lithography operation within a chamber after a template has been brought into contact with resist drops, according to an embodiment of the present invention.

FIG. 3 is a simplified cross-sectional view of an imprint lithography operation within a chamber after the resist layer has been cured and separated from template, according to an embodiment of the present invention.

FIG. 4 is a simplified cross-sectional view of an imprint lithography operation within a chamber after a removal process, according to an embodiment of the present invention.

FIG. 5 is a simplified view of a magnified portion of the surface of a media disc including a pattern of voids after an imprint lithography operation where the environmental gas is He or N₂.

FIG. 6 depicts a flowchart of an exemplary process of forming a media disc, according to some embodiments of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Embodiments of the present invention provide methods for patterned media resist imprinting with substantial local underfill void elimination in the fabrication of recording media. However, embodiments of the invention can be applied to any bit patterned media (“BPM”) and related fabrication techniques and any nanoimprint related semiconductor device fabrication method as long as nanoimprint is needed for patterning step.

Embodiments of the present invention allow for the substantial elimination of voids, e.g. local underfill of mold patterns, during resist imprinting for the production of patterned media. By establishing and maintaining a relatively lower pressure within a chamber, a lower volume of gases are present within the chamber. The lower volume of gases facilitates absorbtion of the gases into resist droplets when resist merging film is formed on a substrate. As a result, quicker throughput and no nanoimprint voids remain after the resist imprinting process. Lowered pressure chamber is purged with suitable volatile template releasing agents so the template is constantly replenished with mold releasing agents to maintain consistent separation performance at each imprint. Resist monomers and photo initiators can also be bled into chamber in the vapor form if needed to increase the chamber vacuum level flexibility.

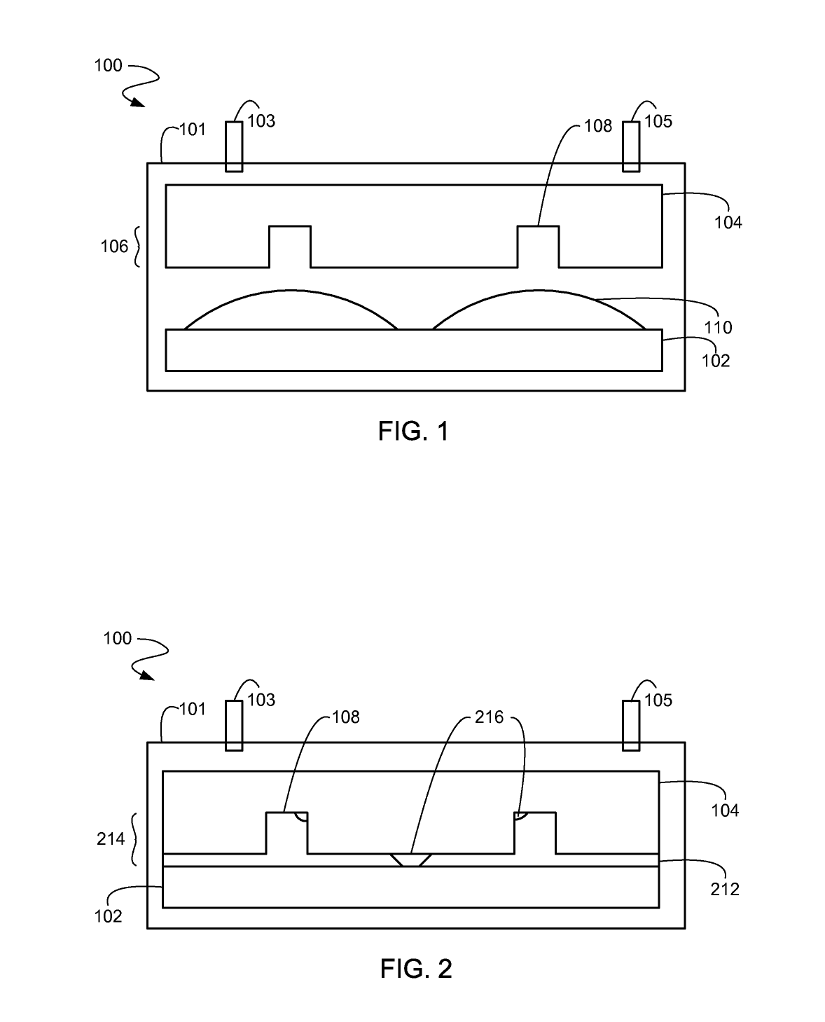

FIG. 1 is a simplified cross-sectional view of an imprint lithography operation 100 within a chamber 101, according to an embodiment of the present invention. The chamber 101 includes a substrate 102 and a template 104. In an embodiment, the substrate may be, for example, an aluminum or glass disc (e.g., 65 mm in diameter with a 20 mm hole), a Si or quartz wafer, or other wafer material. The template 104 is positioned above the substrate 102. The template 104 includes a predetermined pattern 106. In some embodiments, the predetermined pattern 106 includes bands of holes 108 of various sizes.

In various embodiments, the chamber 101 may also include one or more inputs, for example chamber pumping port 103 and a mold releasing agent feed 105. The mold releasing agent feed 105 may also function as a resist monomer/photo initiator feed. The imprint resist is dispensed on the disc substrate 102 and the substrate 102 is transferred into the chamber 101, e.g. through a resist drop dispensing process, prior to the imprint lithography operation 100. The mold releasing agent feed 105 is operable to bleed mold releasing agent, resist monomer, and/or photo initiator vapor within the chamber 101 during the imprint lithography operation 100.

Resist drops 110 may be deposited on the substrate 102, for example by drop-and-dispense methods. In some embodiments, the resist drops 110 may be deposited in the pL and sub pL range in drop volume and about tenth to hundredth μm in spacing between drops. Together with the substrate 102 and the template 104, the resist drops 110 are used in patterning steps based on, for example, drop-and-dispense UV-cure nanoimprint lithography (see below).

The resist film forming process after resist drop dispensing consists of the initial droplet wetting followed by subsequent merging of the droplet array in a confined mold-substrate space. Due to merging of resist droplets in the confined mold-substrate space, gas in the chamber 101 may become trapped in the resist droplets, thus leading to local resist under fill-(see below). This local resist underfill may cause pattern transfer failure.

During the imprint lithography process, a pressure (e.g. vacuum level) may be set within the chamber 101 at a range such that one or more constituent gases within the chamber 101 remain below their Henry's law equilibrium. Mold releasing agent, resist monomer, photo initiator, and a selected inert gas may be injected into the chamber 101, and the vacuum level is maintained in order to suppress resist evaporation. For example, the mold releasing agent and resist monomers with photo initiators may be injected into the chamber 101 via the mold releasing agent feed 105. In various embodiments, other feeds and/or methods of removing and adding gasses may be used. In an even further embodiment, the inert gas has a Henry's law equilibrium two orders of magnitude greater than a Henry's law equilibrium of He and/or N₂.

Establishing a vacuum level such that one or more constituent gases within the chamber 101 remain below their Henry's law equilibrium. As a result, the lower volume of gas present within the chamber 101 is more readily absorbed by the resist drops 110. This minimizes imprint defects resulting from unabsorbed gas and maximizes throughput. In an embodiment, mold releasing agent may be added to the chamber 101 during subsequent imprint lithography operations.

FIG. 2 is a simplified cross-sectional view of an imprint lithography operation 100 within the chamber 101 after the template 104 has been brought into contact with the resist drops 110 (FIG. 1), according to an embodiment of the present invention. The template 104 causes the resist drops 110 (FIG. 1) to spread, thus forming a resist layer 212. During an imprint spread time (defined as the time between when the template starts to contact the resist and when UV-irradiation is applied to cure the resist), the resist layer 212 spreads across the template 104 and the substrate 102. In an embodiment, the resist pattern 214 may be a negative image of the predetermined pattern 106 (FIG. 1).

In some embodiments, a series of voids 216, e.g. nano-scale voids, are formed in the resist layer 212 at the boundaries between the resist drops 110 (FIG. 1) and in the template recessed feature after spreading. For example, the voids 216 may be about 10 nm to a few μm in size, and may be formed as the result of gas bubbles that are trapped due to incomplete absorption of gas molecules by the resist layer 212. Furthermore, the voids 216 may form as a result of local resist underfill in the bands of holes 108 in the predetermined pattern 106 (FIG. 1).

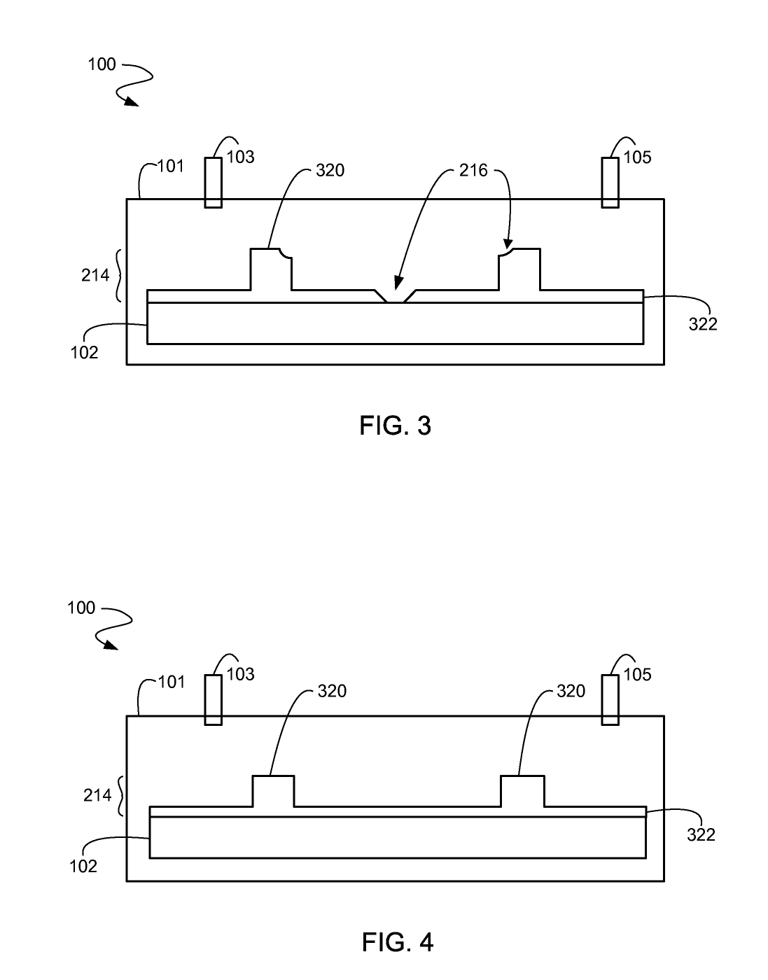

FIG. 3 is a simplified cross-sectional view of an imprint lithography operation 100 within the chamber 101 after the resist layer 212 (FIG. 2) has been cured, according to an embodiment of the present invention. The resist layer 212 (FIG. 2) has been cross linked, for example by UV-light irradiation, and has hardened and solidified into a rigid resist layer 322. The rigid resist layer 322 may include the voids 216 and the resist bumps 320. The template 104 (FIG. 2) has been separated from the rigid resist layer 322 and the substrate 102, leaving the rigid resist layer 322 including the resist pattern 214 attached to the substrate 102.

FIG. 4 is a simplified cross-sectional view of an imprint lithography operation 100 within the chamber 101 when CO₂ is used as an inert gas, according to an embodiment of the present invention. The use of CO₂ as an inert gas allows for the creation of a quick absorption under low pressure environment in the chamber 101. By establishing and maintaining a low pressure within the chamber 101, a lower volume of gases are present within the chamber and are quickly absorbed into resist droplets on the substrate 102, resulting in nanoimprint void elimination 216 (FIG. 2) after the resist imprinting process. Thus, a predetermined predictable pattern of the resist bumps 320 may be substantially free of the voids 216.

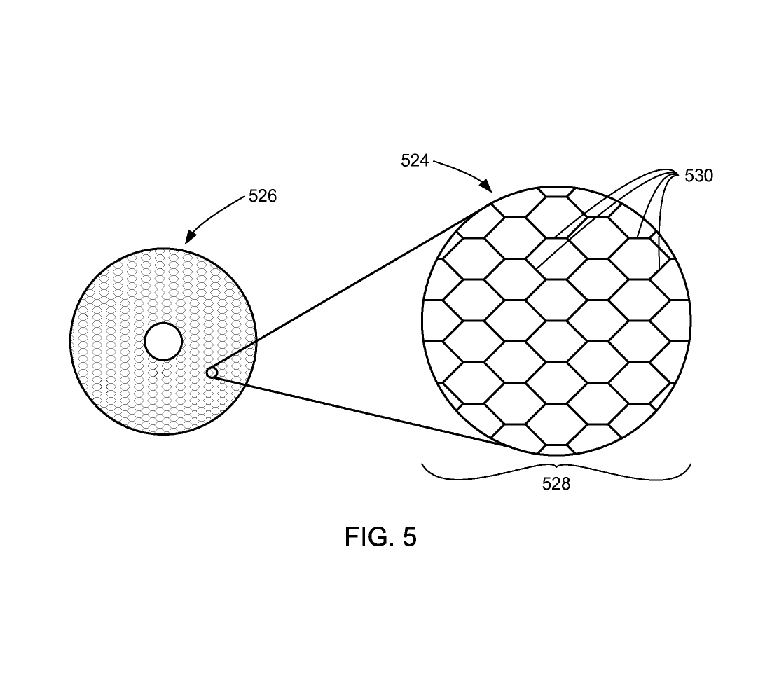

FIG. 5 is a simplified view of a magnified portion 524 of the surface of a media disc 526 including a pattern 528 of voids lines 530 after an imprint lithography operation 100 (FIG. 1) where the environmental gas is He or N₂, for example. As described above, the void lines 530 may form at the boundaries of resist drops as they spread together during imprinting. Additionally, as described above, voids lines 530 are the result of resist local underfill (FIG. 2). The void lines 530 thus form the unwanted pattern 528, sometimes referred to as a “fishnet” pattern, on the surface of the media disc 526. When He (or other gas having a solubility in the resist similar to or lower than He) is used as the environmental gas during imprinting, the void lines 530 serve as resist local underfill indication when inspected by optical and electron beam inspection methods. The resist local underfill causes pattern transfer failure.

Under a CO₂ based non-vacuum imprint environment, the volume size of the void lines 530 may be substantially reduced (e.g. by 50%). In various embodiments the volume size of the void lines 530 may be substantially eliminated. Thus, CO₂'s high Henry's constant behavior compared to He, provides for significant local underfill reduction and smaller “fishnet” patterns during imprint lithography.

Therefore as described above, various embodiments may include one or more means for reducing the size of nano-scale voids. For example, in an embodiment a pressure may be set within the chamber at a range such that one or more constituent gases within the chamber remain below their Henry's law equilibrium. For example, in an embodiment an inert gas has a Henry's law equilibrium two orders of magnitude greater than a Henry's law equilibrium of He and/or N₂. For example, in an embodiment the use of CO₂ as an inert gas may allow quick absorption under low pressure environment in the chamber. For example, in an embodiment an inert gas may have a solubility in a resist layer greater than the solubility of He.

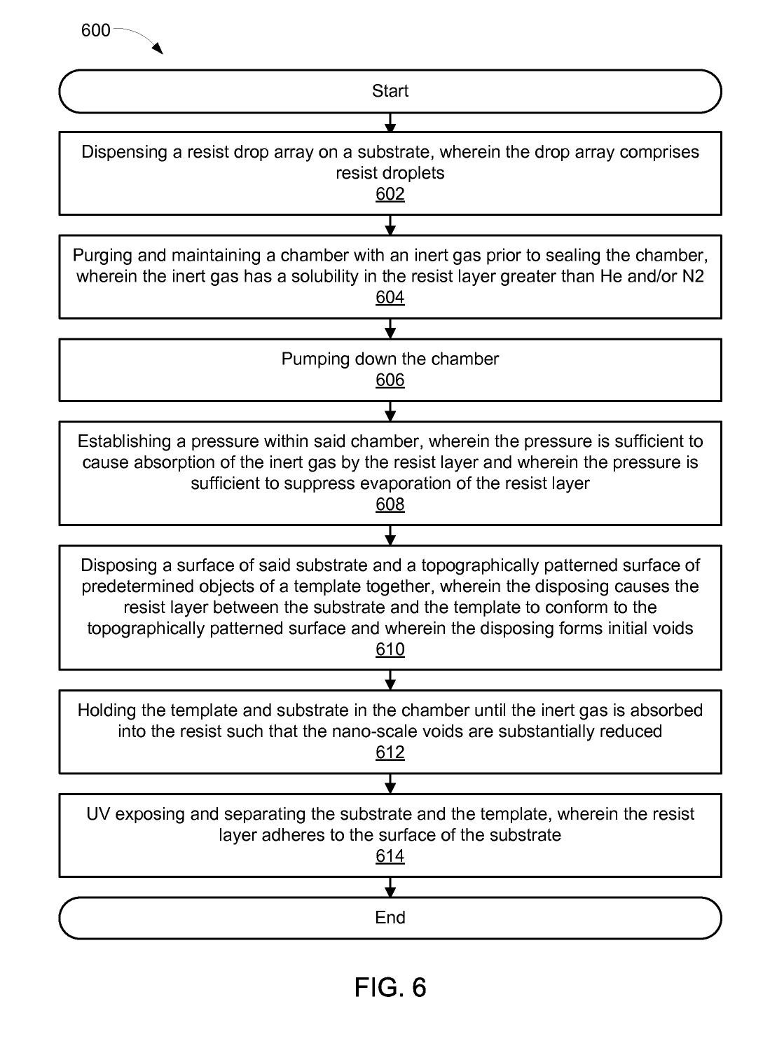

FIG. 6 depicts a flowchart 600 of an exemplary nanoimprint fabrication process on a magnetic media disc, according to some embodiments of the present invention. In block 602, resist is dispensed on a substrate outside a chamber for resist layer preparation, wherein the resist layer includes resist droplets. In some embodiments, dispensing the resist layer includes drop-dispensing the resist layer. For example, in FIG. 1, the resist drops may be jet deposited on the substrate by ink jet drop dispensing methods. The resist drops may be deposited with in the pL and sub pL range in drop volume and at about tenth to hundredth μm in spacing between drops.

In block 604 of FIG. 6, an inert gas is pumped and maintained within a chamber prior to the chamber being sealed, wherein the inert gas has a solubility in the resist layer much greater than He and/or N₂. Sealing the chamber allows for pumping of ambient gas. In some embodiments, the chamber may include a substrate and a template. The chamber may be operable for fabrication of a pattern using imprint lithography. For example, in FIG. 1, the chamber, including the substrate and template, is sealed prior to the start of an imprint operation. In another example, in FIG. 1, an inert gas (e.g. CO₂) may be injected into the chamber prior to bringing the template into contact with the resist drops. In an embodiment, after pumping the inert gas into the chamber, the inert gas may be substantially the only gas in the chamber.

In block 606 of FIG. 6, the chamber is pumped down and purged with an inert gas where the template is present. For example, in FIG. 1, after pumping and maintaining the inert gas into the chamber, the chamber is then partially pumped to reduce pressure. Mold releasing agent, monomer, and/or photo initiator vapors are fed in through the port, if necessary, to maintain template releasing quality and suppression of resist drop evaporation. In an embodiment, the chamber is pumped to a lowered pressure subsequent to placing a substrate within the chamber.

In block 608 of FIG. 6, a pressure is established within the chamber, wherein the pressure is sufficient to cause absorption of the inert gas by the resist layer, and wherein the pressure is sufficient to suppress evaporation of the resist layer. In some embodiments, establishing the pressure within the chamber may further include establishing a vacuum within the chamber wherein the vacuum level is below a Henry's law equilibrium for the inert gas. For example, in FIG. 1, prior to bringing the template into contact with the resist drops, a vacuum level below a Henry's law equilibrium for CO₂ may be established within the chamber. The pressure may be sufficient such that the CO₂ gas is absorbed by the resist layer and such that evaporation of the resist layer is suppressed.

In block 610 of FIG. 6, a surface of the substrate and a topographically patterned surface of a template are disposed together, wherein the disposing causes the resist layer between the substrate and the template to conform to the topographically patterned surface, and wherein the contacting forms initial voids among merging resist drops. For example, in FIG. 2, the template has been brought into contact with the resist drops. The template causes the resist drops to spread, thus forming a resist layer. The resist layer spreads across the template and the substrate, filling the bands of holes and forming a resist pattern. The template-resist film-substrate is held for a short period of time until the trapped gas is devolved.

In block 612 of FIG. 6, the template and substrate are held in the chamber until the inert gas is absorbed into the resist such that the nano-scale voids are substantially eliminated. In some embodiments, the reducing includes substantially removing the nano-scale voids. In another embodiment, the reducing includes absorbing the inert gas into the resist layer. In another example, in FIG. 1, an inert gas (e.g. CO₂) may be injected into the chamber. Use of the inert gas (e.g. CO₂) at a lower pressure within the chamber reduces the volume of constituent gases within the chamber. The lower volume of constituent gases may be absorbed into the resist layer located on the substrate, within the chamber. Since the gases are absorbed into the resist layer, the nano-scale voids are substantially reduced.

In block 614 of FIG. 6, UV exposure is performed and the chamber is brought back to normal pressure and the substrate and the template are then separated, wherein the resist layer adheres to the surface of the substrate. For example, in FIG. 4, the template has been separated from the rigid resist layer and the substrate, leaving the rigid resist layer including the resist pattern attached to the substrate.

In some embodiments, the process of forming a media disc depicted in FIG. 6 may further include establishing a vacuum within the chamber wherein the vacuum is is between 0.1% to 50% of atmospheric pressure. For example, in FIG. 1, prior to bringing the template into contact with the resist drops, a vacuum level is between 0.1% to 50% of atmospheric pressure may be established within the chamber.

In some embodiments, the process of forming a media disc depicted in FIG. 6 may further include injecting a resist monomer and photo initiator vapor within the chamber. For example, in FIG. 1, prior to bringing the template into contact with the resist drops, a resist monomer and photo initiator vapor may be injected into the chamber.

In some embodiments, the process of forming a media disc depicted in FIG. 6 may further include injecting a mold releasing agent vapor within the chamber. For example, in FIG. 1, prior to bringing the template into contact with the resist drops, a mold releasing agent vapor may be injected within the chamber via the mold releasing agent feed. In an embodiment, the chamber 101 is maintained with some mold releasing agent vapor after every imprint lithography operation.

It can be appreciated that the process of forming a media disc illustrated in FIG. 6 can be automated using a system including a processor and a memory coupled to the processor, wherein the memory includes instructions that when executed cause the system to perform the process. The system may be operable for fabrication of a scale pattern using the imprint lithography operation.

In another embodiment, the pressure established within the chamber may be maintained throughout an imprint lithography operation. For example, in FIG. 1, the pressure within the chamber may be monitored by an external system (not shown). If the external system detects a change in pressure exceeding a predefined threshold, CO₂ may be injected or pumped to maintain the desired pressure setting within the chamber.

In some embodiments, the process of forming a media disc depicted in FIG. 6 may further include maintaining a predefined pressure within the chamber during an imprint lithography operation. For example, in FIG. 1, a predefined pressure is maintained during the chamber for the duration of the imprint lithography operation.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

What is claimed is:

1. A method comprising:
dispensing a resist layer on a substrate, wherein said resist layer comprises resist droplets;
purging an inert gas within a chamber, wherein said inert gas has a solubility in said resist layer greater than the solubility of He;
disposing a surface of said substrate and a topographically patterned surface of predetermined objects of a template together within said chamber, wherein said disposing causes said resist layer between said substrate and said template to conform to said topographically patterned surface, and wherein further said disposing forms nano-scale voids;
reducing size of said nano-scale voids; and
separating said substrate and said template, wherein said resist layer adheres to said surface of said substrate.

2. The method of claim 1 further comprising injecting a resist monomer or photo initiator vapor within said chamber, and maintaining a vacuum level wherein one or more constituent gases within said chamber remain below their Henry's law equilibrium.

3. The method of claim 1 further comprising injecting and replenishing a mold releasing agent vapor within said chamber, and maintaining a vacuum level wherein one or more constituent gases within said chamber remain below their Henry's law equilibrium.

4. The method of claim 1 wherein said chamber is operable for fabrication of a pattern using imprint lithography under a vacuum environment wherein one or more constituent gases within said chamber remain below their Henry's law equilibrium.

5. The method of claim 1 further comprising establishing a vacuum within said chamber wherein said vacuum level is below a Henry's law equilibrium for said inert gas.

6. The method of claim 1, wherein after said purging, said inert gas is substantially the only gas in said chamber and wherein further said inert gas has a Henry's law equilibrium two orders of magnitude greater than a Henry's law equilibrium of He.

7. The method of claim 1, wherein said reducing size comprises absorbing said inert gas into said resist layer.

8. A method comprising:
sealing a chamber;
filling said chamber with an ambient inert gas, wherein said inert gas has a solubility in a resist layer on a substrate greater than the solubility of He; and
establishing a pressure within said chamber sufficient to cause absorption of said ambient inert gas by said resist layer, and sufficient to suppress evaporation of said resist layer.

9. The method of claim 8, further comprising:
dispensing said resist layer on a substrate within said chamber, wherein said resist layer comprises resist droplets;
purging an inert gas within said chamber, wherein said inert gas has a solubility in said resist layer greater than He;
disposing a surface of said substrate and a topographically patterned surface of predetermined objects of a template together, wherein said disposing causes said resist layer between said substrate and said template to conform to said topographically patterned surface, and wherein further said disposing forms nano-scale voids;
reducing size of said nano-scale voids; and
separating said substrate and said template, wherein said resist layer adheres to said surface of said substrate.

10. The method of claim 8 wherein said inert gas is has a Henry's law equilibrium two orders of magnitude greater than a Henry's law equilibrium of He.

11. The method of claim 8 wherein said chamber is operable for fabrication of a pattern using imprint lithography under a vacuum environment wherein one or more constituent gases within said chamber remain below their Henry's law equilibrium.

12. The method of claim 8 further comprising maintaining a predefined pressure within said chamber during an imprint lithography operation.

13. The method of claim 8 wherein said establishing is below a Henry's law equilibrium for said inert gas.

14. The method of claim 8, wherein said reducing further comprises substantially eliminating said nano-scale voids.

15. An apparatus comprising:
a sealed chamber filled with an inert gas;
a surface of a substrate and a topographically patterned surface of predetermined objects of a template within said sealed chamber, forming nano-scaled voids therebetween; and
a means for reducing the size of said nano-scale voids.

16. The apparatus of claim 15, wherein said means for reducing includes purging said inert gas, wherein said inert gas has a solubility in a resist layer greater than the solubility of He.

17. The apparatus of claim 15, wherein said means for reducing includes establishing a pressure within said sealed chamber sufficient to cause absorption of said inert gas by a resist layer.

18. The apparatus of claim 17, wherein said means for reducing further includes establishing said pressure within said sealed chamber sufficient to suppress evaporation of said resist layer.

19. The apparatus of claim 15, further comprising a resist layer on said surface of said substrate, wherein said resist layer includes said nano-scale voids.

20. The apparatus of claim 15, further comprising a vacuum within said chamber, wherein said vacuum level is between 0.1% to 50% of atmospheric pressure.
